(19) United States
(12) Patent Application Publication
(10) Pub. No.: US 2008/0278338 A1
(43) Pub. Date: Nov. 13, 2008

(54) DROWNING ALERT SYSTEM

(76) Inventor: Jordan Michael Krell, Plankinton, SD (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(21) Appl. No.: 12/116,766

(22) Filed: May 7, 2008

Related U.S. Application Data
(60) Provisional application No. 60/917,213, filed on May 10, 2007.

(51) Int. Cl. G08B 23/00

(52) U.S. Cl. 340/573.6

(57) ABSTRACT

A drowning alert system including a transmission device and a base station is provided. The transmission device is supported by a user and suitable for use within water. The transmission device includes a radio frequency transmitter configured to broadcast a radio frequency signal. The base station includes a radio frequency receiver configured to receive the radio frequency signal. The base station is configured to activate an indicator in response to the radio frequency transmitter being submerged in the water. The base station is also configured to activate an alarm in response to the radio frequency transmitter being submerged in the water for a predetermined amount of time.

### CROSS-REFERENCE TO RELATED PATENT APPLICATIONS

This patent application claims the benefit of U.S. Provisional Patent Application No. 60/917,213, filed May 10, 2007, the teachings and disclosure of which are hereby incorporated in their entireties by reference thereto.

### BACKGROUND

There are several different types of commercially available drowning alert systems, each of which operate in a different manner. For example, one type of drowning alert system appears to sense when a user makes contact with a liquid such as, for example, water. When the user comes into contact with the water, a sending device transmits an electromagnetic signal to a receiving device. Upon receipt of the electromagnetic signal, the receiving device produces an alarm.

Another type of drowning alert system senses how close a user is to a body of water such as, for example, a swimming pool. When the user ventures too close to the body of water, the drowning alert system produces an alarm. Yet another type of drowning alert system monitors the motion, or lack thereof, of a user within the body of water. If the motion patterns monitored by the system indicate that the user is believed to be in distress, the drowning alert system generates an alarm.

### BRIEF DESCRIPTION OF THE DRAWINGS

The accompanying drawings incorporated in and forming a part of the specification illustrate several aspects of the present disclosure and, together with the description, serve to explain the principles of the present disclosure. In the drawings:

FIG. 1 is an embodiment of a drowning alert system;

FIG. 2 is an embodiment of a transmission device of the drowning alert system of FIG. 1;

FIG. 3 is an embodiment of a base station of the drowning alert system of FIG. 1; and

FIG. 4 is the drowning alert system of FIG. 1 in use in the context of a swimming pool.

### DETAILED DESCRIPTION OF THE DRAWINGS

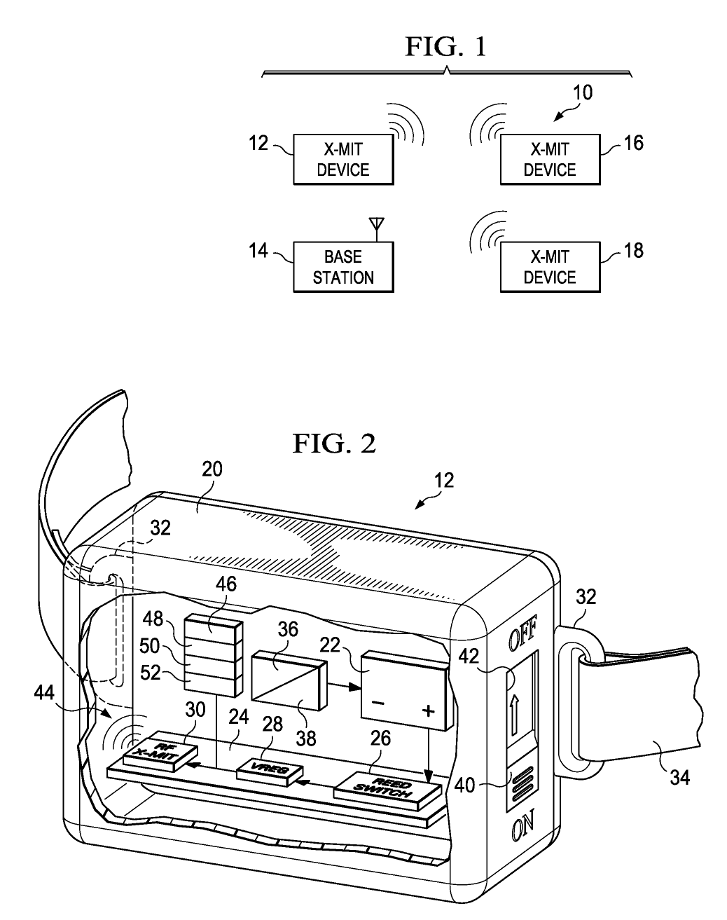

Referring to FIG. 1, a drowning alert system 10 is illustrated. As will be more fully explained below, drowning alert system 10 provides an initial warning when, for example, a person (e.g., an infant, child, etc.), or the head of that person, has gone underwater and a subsequent warning when the person, or the head of that person, has been underwater for a potentially dangerous length of time. If the subsequent warning is emitted, a supervising individual and/or a potential rescuer (e.g., a parent, lifeguard, bystander, etc.) is alerted to the situation and afforded the opportunity to provide aid to the person in the water if aid is needed.

As shown in FIG. 1, drowning alert system 10 includes a transmission device 12 and a base station 14. In addition to transmission device 12, drowning alert system 10 may also include additional transmission devices such as, for example, transmission device 16 and transmission device 18 as depicted in FIG. 1. With the exception of emitting their own identifiable radio frequency signal, which will be more fully explained below, transmission device 16 and transmission device 18 are substantially similar to transmission device 12. Therefore, for the sake of brevity, in several of the following paragraphs reference is made to transmission device 12 alone.

As shown in FIG. 2, transmission device 12 includes a housing 20 encapsulating a power source 22 and a circuit board 24 that supports a switch 26, a voltage regulator 28, and a transmitter 30. Housing 20 is formed from a material that is impervious to liquids (e.g., water) yet permits radio frequency signals to pass therethrough. In addition, housing 20 may be corrosion resistant and, therefore, suitable for exposure to, for example, salt water. Housing 20 may be formed from a variety of suitable materials such as, for example, plastic, polyester, and polyvinyl chloride (PVC).

Still referring to FIG. 2, housing 20 is equipped with a mounting structure 32. Mounting structure 32 is employed to conveniently and safely secure transmission device 12 to an article 34 of clothing or equipment typically worn or supported by a user in and around a body of water (e.g., a swimming pool, lake, river, etc.). Article 34 may be, for example, a pair of swim goggles, a headband, a necklace, or an armband that is conveniently and comfortably worn around the head, neck, or arm of the user while the user is in and around the body of water.

In FIG. 2, power source 22 is a direct current (DC) battery used to provided electrical energy to transmission device 12. In some embodiments, power source 22 is a replaceable battery such as, for example, an alkaline battery. In other embodiments, power source 22 is a rechargeable battery such as, for example, a lithium ion battery. Where power source 22 is a rechargeable battery, transmission device 12 may include an intelligent charger 36 that prevents the battery from being overcharged. In addition, transmission device 12 may also include a wireless charging module 38 configured to recharge battery 22 with radio frequency signals received by transmission device 12 or another device. In one embodiment, power source 22 may be recharged using alternating current (AC) by equipping transmission device 12 with an AC to DC converter and a connector suitable for coupling transmission device 12 to a standard AC source (e.g., a standard 110 V outlet).

Power source 22 is in electrical communication with switch 26. Switch 26 is used to transition transmission device 12 between an operating state (i.e., where the device is turned “on”) and a non-operating state (i.e., where the device is turned “off”). When switch 26 has placed transmission device 12 in the operating state, electrical energy from power source 22 is available to voltage regulator 28 and transmitter 30. In contrast, when switch 26 has placed transmission device 12 in the non-operating state, electrical energy from power source 22 is withheld from voltage regulator 28 and transmitter 30.

In FIG. 2, switch 26 is depicted in the form of a reed switch transitioned between states by an applied magnetic field. To supply the magnetic field, a magnet 40 is slideably mounted within a slot 42 formed in housing 20. When magnet 40 is moved out of the position depicted in FIG. 2, transmission device 12 is placed in the non-operating state. Conversely, when magnet 40 is moved into and maintains the position illustrated in FIG. 2, transmission device 12 is placed in the operating state.

Switch 26 is in electrical communication with voltage regulator 28. Therefore, when switch 26 is closed, voltage regulator 28 is supplied with electrical charge from power source 22. In FIG. 2, voltage regulator 28 decreases (e.g., steps down) the level of voltage provided by power supply 22 to an operating voltage level of voltage for transmitter 30. If the level of voltage supplied by power source 22 is comparable to the level of voltage needed to operate transmitter 30, then voltage regulator 28 may be unnecessary within transmission device 12.

Voltage regulator 28 is in electrical communication with transmitter 30. Transmitter 30 generally broadcasts an electromagnetic signal such as, for example, a radio frequency signal 44 in the range of about 3 kHz to about 300 GHz. In some embodiments, transmitter 30 emits radio frequency signal 44 at about 2.4 GHz. At this frequency, radio frequency signal 44 will be largely and/or substantially attenuated (i.e., absorbed) by water. In other words, radio frequency signal 44 is unable to travel a substantial distance, if at all, through water. The precise amount of attenuation of radio frequency signal 44 may depend upon a number of factors such as, for example, the properties and/or characteristics of the water, the path of propagation, the strength of transmitter 30, and the like.

In some embodiments, transmission device 12 may be equipped with a global positioning system (GPS) module 46 to facilitate location of transmission device 12. In addition, transmission device 12 may be outfitted with a distance monitoring device 48 that monitors or helps to monitor the distance between transmission device 12 and base station 14 to ensure that the distance is within an acceptable or safe range (e.g., 25 feet) as subjectively determined by the individual supervising the wearer of transmission device 12. Transmission device 12 may also include a removal alarm 50 that activates if transmission device 12 is accidentally removed from the user, intentionally removed from the user, and the like. In addition, transmission device 12 may include a low battery alarm 52 warning of a depleted battery condition.

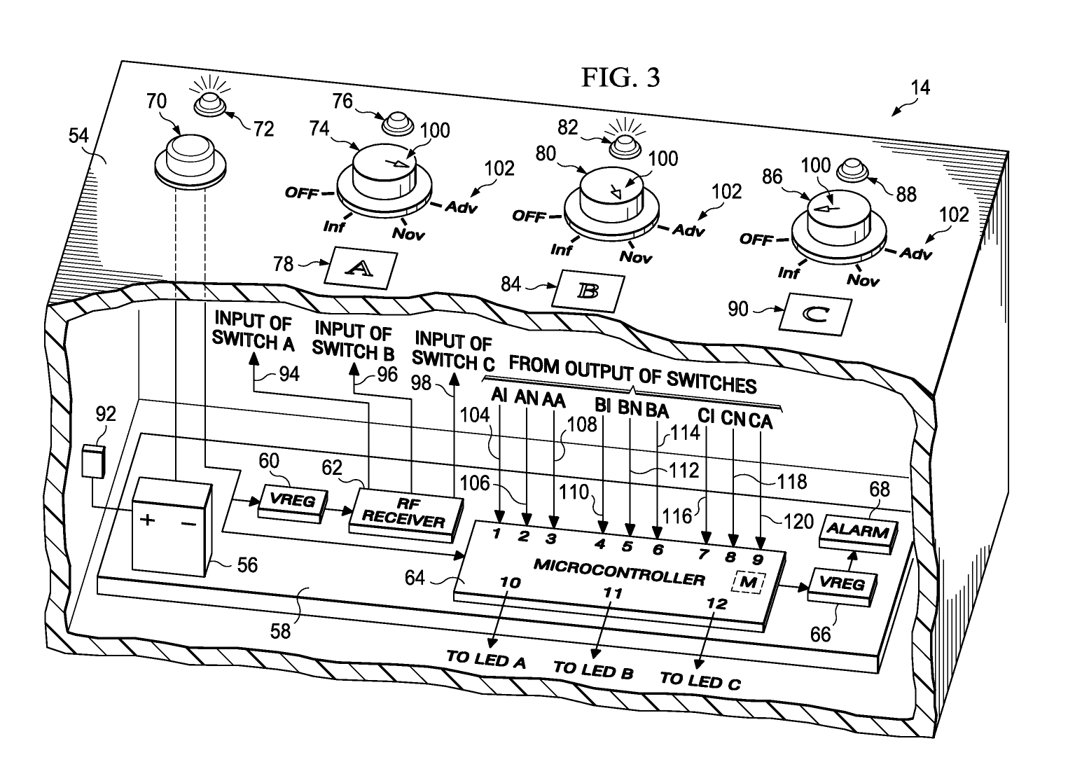

Referring now to FIG. 3, base station 14 includes a housing 54 protectively covering a power source 56 and a circuit board 58 that supports a voltage regulator 60, a receiver 62, a microcontroller 64, another voltage regulator 66, and an alarm 68. Housing 54 also supports a power switch 70 and an associated visual indicator 72, a selector switch 74 and a visual indicator 76 associated with a Channel “A” 78, a selector switch 80 and a visual indicator 82 associated with a Channel “B” 84, and a selector switch 86 and a visual indicator 88 associated with a Channel “C” 90. The interaction between these components on and in base station 14 is detailed below.

As shown in FIG. 3, power source 56 is a direct current (DC) battery used to provided electrical energy to base station 14. In some embodiments, power source 56 is a replaceable battery such as, for example, an alkaline battery. In other embodiments, power source 56 is a rechargeable battery such as, for example, a lithium ion battery. Where power source 56 is a rechargeable battery, base station 14 may include an intelligent charger 92 that prevents the battery from being overcharged. In one embodiment, power source 56 may be recharged by equipping base station 14 with an AC to DC converter and a connector suitable for coupling base station 14 to a standard AC source (e.g., a standard 110 V outlet).

Power source 56 is in electrical communication with power switch 70. Power switch 70 is used to transition base station 14 between an operating state (i.e., where the base station is turned “on”) and a non-operating state (i.e., where the base station is turned “off”). When power switch 70 has placed base station 14 in the operating state, electrical energy from power source 56 illuminates visual indicator 72, which may be a light-emitting diode (LED), as shown in FIG. 3. In addition, electrical energy is made available to voltage regulator 66 and microcontroller 64. In contrast, when power switch 70 has placed base station 14 in the non-operating state, visual indicator 72 is not illuminated and electrical energy from power source 56 is withheld from voltage regulator 66 and microcontroller 64.

In FIG. 3, voltage regulator 66 decreases (i.e., steps down) the level of voltage provided by power source 56 to an operating voltage level for receiver 62. If the level of voltage supplied by power source 56 is comparable to the level of voltage needed to operate receiver 62, then voltage regulator 66 may be unnecessary within base station 14.

Voltage regulator 60 is in electrical communication with receiver 62. Receiver 62 is configured to receive an electromagnetic signal such as, for example, radio frequency signal 44 broadcast by transmitter 30 of transmission device 12. When receiver 62 is receiving radio frequency signal 44, receiver 62 outputs or maintains a low voltage (e.g., about zero volts) on output line 94 coupled to selector switch 74, on output line 96 coupled to selector switch 80, and on output line 98 coupled to selector switch 86. However, when receiver 62 fails to receive radio frequency signal 44, receiver 62 outputs a high voltage (e.g., about three to about five volts) on output line 94, output line 96, or output line 98 depending on whether receiver 62 lost radio frequency contact with transmission device 12, transmission device 16, or transmission device 18, respectively.

Receiver 62 is in electrical communication with selector switch 74, selector switch 80, and selector switch 86. Selector switch 74, selector switch 80, and selector switch 86 are each generally employed to prevent or permit electrical energy from reaching microcontroller 64. In FIG. 3, selector switch 74 is associated with Channel A 78, selector switch 80 is associated with Channel B 84, and selector switch 86 is associated with Channel C 90. Also, as shown in FIG. 3, selector switch 74, selector switch 80, and selector switch 86 are each a rotary switch having four discrete settings. However, in other embodiments different types of switches may be employed.

Each of selector switch 74, selector switch 76, and selector switch 80 is provided with a position indicator 100 in the form of an arrow. In addition, housing 20 proximate each of selector switch 74, selector switch 76, and selector switch 80 is provided with some form of identifying indicia 102, which may include, for example, letters, numbers, phrases and abbreviations. Using indicator 100 and indicia 102 collectively, selector switch 74, selector switch 76, and selector switch 80 may be rotated into a desired one of the available settings.

As an example, and referring to FIG. 3, when indicator 100 of selector switch 74 is rotated into alignment with the phrase “OFF” on housing 20, channel A 78 is turned off and transmission device 12 associated with channel A 78 is not being monitored. When indicator 100 of selector switch 74 is rotated into alignment with the abbreviation “INF,” which represents an infant swimmer, transmission device 12 associated with channel A 78 is being monitored and a three second setting is selected. When indicator 100 of selector switch 74 is rotated into alignment with the abbreviation “NOV,” which represents a novice swimmer, transmission device 12 associated with channel A 78 is being monitored and a fifteen second setting is selected. Finally, when indicator 100 of selector switch 74 is rotated into alignment with the abbreviation “ADV,” which represents an advanced swimmer, transmission device 12 associated with channel A 78 is being monitored and a thirty second setting is selected.

It should be understood that in other embodiments, selector switch 74, selector switch 76, and selector switch 80 may offer more or fewer settings than depicted in FIG. 3. In addition, the settings in other embodiments may relate to longer or shorter durations of time (e.g., an novice swimmer setting may be seven seconds, an advanced swimmer setting may be twenty seconds, etc.). Also, indicia 102 on housing 54 may be a series of letters and/or numbers where the numbers represent seconds (e.g., OFF, 4, 15, 30, etc.) or numbers representing a relative position of the particular switch (e.g., 0, 1, 2, 3, etc.) instead of the words and abbreviations shown in FIG. 3.

Selector switch 74, selector switch 80, and selector switch 86 are each in electrical communication with microcontroller 64. In turn, microcontroller 64 is in electrical communication with visual indicator 76, visual indicator 82, and visual indicator 88, each of which is depicted in FIG. 3 as a light-emitting diode (LED). In some embodiments, visual indicator 72, visual indicator 82, and visual indicator 88 may be an audible indicator, an alarm, or another type of notification device. Microcontroller 64 is also in electrical communication with voltage regulator 66 and alarm 68. Therefore, microcontroller 64 is able to execute a set of instructions, which may be resident in memory as software code or embedded in firmware, using data and/or signals generated by receiver 62 and passed through selector switch 74, selector switch 76, and/or selector switch 80, to regulate activation of visual indicator 76, visual indicator 82, visual indicator 88 and/or alarm 68.

As shown in FIG. 3, selector switch 74 has an output line 104 labeled “AI” (representing channel A 78 and an Infant swimmer setting) coupled to pin 1 on microcontroller 64. Selector switch 74 also has an output line 106 labeled “AN” (representing channel A 78 and a Novice swimmer setting) coupled to pin 2 on microcontroller 64 and an output line 108 labeled “AA” (representing channel A 78 and an Advanced swimmer setting) coupled to pin 3 on microcontroller 64. Using the same general naming convention, selector switch 80 has an output line 110 labeled “BI” coupled to pin 4, an output line 112 labeled “BN” coupled to pin 5, and an output line 114 labeled “BA” coupled to pin 6. Further, selector switch 86 has an output line 116 labeled “CI” coupled to pin 7, an output line 118 labeled “CN” coupled to pin 8, and an output line 120 labeled “CA” coupled to pin 9.

Still referring to FIG. 3, pin 10 of microcontroller 64 is coupled to visual indicator 76, pin 11 of microcontroller 64 is coupled to visual indicator 82, and pin 12 of microcontroller 64 is coupled to visual indicator 88. It should be understood that the number of pins available on microcontroller 64 may be significantly more than depicted in FIG. 3 depending on, for example, the size and type of microcontroller 64 selected. In addition, it should be understood that the pin designations used herein (e.g., pin 1, pin 2, etc.) are for illustrative purposes only and that each microcontroller will have its own particular pin layout.

Voltage regulator 66 of FIG. 3 increases (e.g., steps up) the level of voltage provided by microcontroller 64 to the level of voltage desired to be delivered to alarm 68. If the level of voltage supplied by microcontroller 64 is comparable to the level of voltage desired for alarm 68, then voltage regulator 66 may be unnecessary within base station 14. In other embodiments, voltage regulator 66 may be another electrical component operable to increase a received voltage and to a higher output voltage such as, for example, a Darlington array.

Voltage regulator 66 is in electrical communication with alarm 68. When appropriately powered by voltage regulator 66, alarm 68 is able to emit an audible warning of at least about ninety-five decibels. To facilitate the distribution of the audible warning, a plurality of apertures may be formed in housing 20 proximate alarm 68. Depending on the type chosen, alarm 68 may issue, for example, a steady warning, a series of chirps, and/or another type of audible warning. In some embodiments, alarm 68 may be an alarm providing another type of sensory-based warning such as, for example, a visual alarm and a vibratory alarm.

In operation, and with reference to FIGS. 1-4, one user 122 is outfitted with transmission device 12, which is associated with Channel A 78, and another user 124 is outfitted with transmission device 16 associated with Channel B 84. Because only two users, namely user 122 and user 124 are monitored in this example, transmission device 18, which is associated with Channel C 90, is unused.

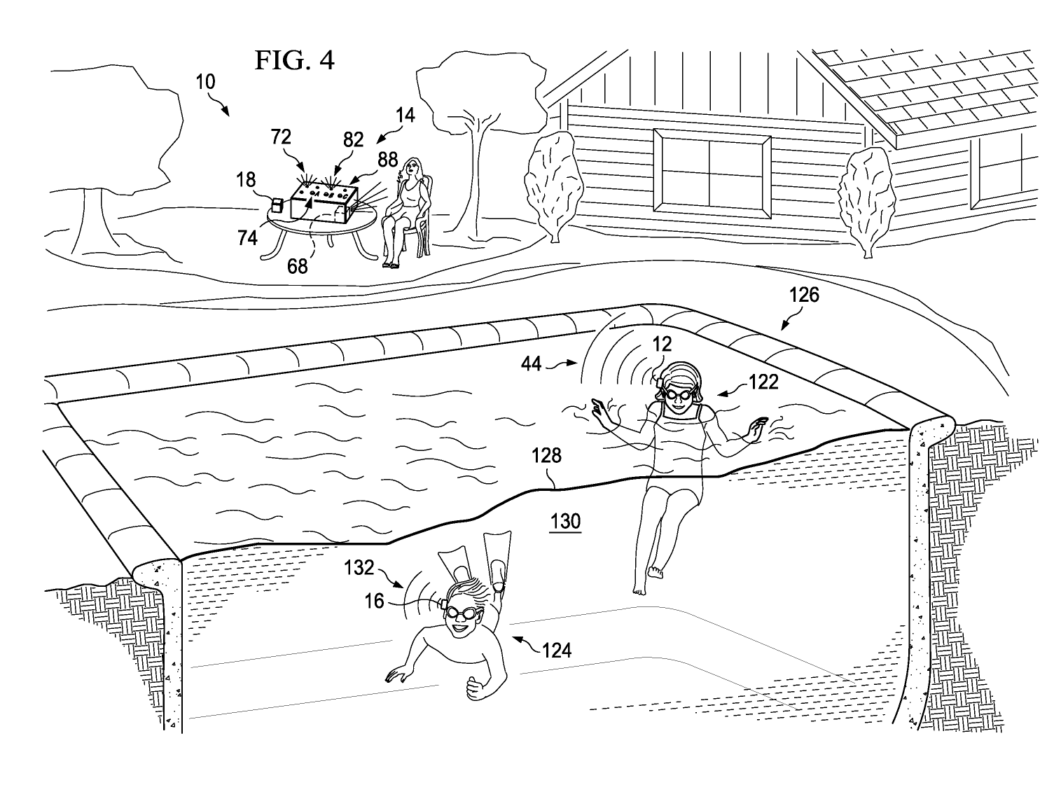

To activate transmission device 12 and transmission device 16, magnet 40 is positioned proximate switch 26. With transmission device 12 and transmission device 12 now active, power switch 70 is employed to turn base station 14 on and to illuminate visual indicator 72. With visual indicator 72 illuminated as shown in FIG. 4, an individual supervising user 122 and user 124 is visually notified that base station 14 is powered.

After activating base station 14 with power switch 70, the supervising individual moves selector switch 74 associated with Channel A 78 and transmission device 12 to the desired setting. For example, where user 122 is an advanced swimmer, selector switch 74 is rotated until position indicator 100 is aligned with indicia 102 having the abbreviation “ADV.” Next, the supervising individual moves selector switch 80 associated with Channel B 84 and transmission device 16 to the desired setting. For example, where user 124 is a novice swimmer, selector switch 80 is rotated until position indicator 100 is aligned with indicia 102 having the abbreviation “NOV.” Because there is no user presently using transmitter 18 associated with Channel C 90, selector switch 86 is left in the non-operating position where position indicator 100 is aligned with indicia 102 having the abbreviation “OFF.” Thus, the different settings are based on the general capability or experience level of swimming of an associated user as subjectively determined by the supervising individual.

With transmission device 12, transmission device 16, and base station 14 turned on and the desired settings on base station 14 selected, user 122 and user 124 are able to enter and actively use, for example, a residential swimming pool 126 as illustrated in FIG. 4. Indeed, user 122 and user 124 are able to, for example, swim both above and below surface 128 of water 130 without being undesirably encumbered.

As shown in FIG. 4, transmission device 12 of user 122 remains above surface 128 of water 130 in swimming pool 126. Therefore, transmitter 12 is able to emit radio frequency signal 44 originating from above surface 128 of water 130. As shown, radio frequency signal 44 propagates through the air without substantial difficulty. Thereafter, radio frequency signal 44, which includes data identifying transmitter 12, is received by receiver 62 in base station 14. Because radio frequency signal 44 was received as expected, receiver 62 maintains a low signal on output line 94. With selector switch 74 set to the advanced swimmer setting as noted above, the low signal on output line 94 is relayed to pin 3 of microcontroller 64 through output line 108. Based on the low signal on output line 108, microcontroller 64 takes no action such that visual indicator 76 associated with Channel A 78 remain darks and alarm 68 remains silent. This set of conditions notifies the supervising individual that user 122 is not believed to be in distress.

In contrast to the above, transmission device 16 of user 124 is disposed below surface 128 of water 130 in swimming pool 126. Therefore, transmitter 30 emits an attenuated radio frequency signal 132 below surface 128 of water 130. Attenuated radio frequency signal 132 is absorbed by water 130 and fails to propagate through the air. As such, attenuated radio frequency signal 132, which includes data identifying transmitter 16, is no longer received by receiver 62 in base station 14.

Because attenuated radio frequency signal 132 is not received at base station 14, receiver 62 generates a high signal on output line 96 associated with Channel B 80. With selector switch 96 set to the novice swimmer setting as noted above, the high signal on output line 96 is relayed to pin 5 of microcontroller 64 through output line 112. Based on the high signal on output line 112, microcontroller 64 instructs visual indicator 82 associated with Channel B to illuminate as shown in FIG. 4. The visual indicator 82 remains illuminated while user 124 remains beneath surface 128 of water 130. Therefore, the illuminated visual indicator 82 visually notifies or warns the supervising individual that user 124 wearing transmitter 16 associated with Channel B 84 has gone under water 130.

In addition to illuminating visual indicator 82, microcontroller 64 also interprets the high signal on output line 112, using the set of instructions or firmware therein, to assess the amount of time user 124 remains submerged under water 130. In this example, because selector switch 80 was rotated to a novice setting for user 124, microcontroller 64 initiates a counter that starts incrementally counting toward the predefined and/or acceptable limit of fifteen seconds.

If user 124 resurfaces prior to microcontroller 64 reaching the fifteen second limit, transmitter 16 emits a non-attenuated radio frequency signal (e.g., radio frequency signal 44). When this non-attenuated radio frequency signal from above surface 128 of water 130 is received by receiver 62, receiver 62 generates a low signal on output line 96. The low signal is received by microcontroller 64 through output line 112. Upon receiving the low signal on output line 112, microcontroller 64 extinguishes visual indicator 82 and resets the counter. With visual indicator 82 associated with Channel B 84 no longer illuminated, the supervising individual is no longer warned that user 124 is under water 130.

In contrast, if user 124 fails to resurface prior to microcontroller 64 reaching the fifteen second limit, microcontroller 64 instructs alarm 68 to issue an audible warning to the supervising individual. In some embodiments, alarm 68 is coupled to other “satellite” alarms (e.g., a security alarm in a dwelling), which are remotely located relative to alarm 68, in order to expand the geographic region and locations were the audible warning is received. In any case, the audible warning of alarm 68 alerts the supervising individual that user 124 has been underwater for a period of time equal to, or in excess of, the predetermined amount of time selected using selector switch 80 based on the ability of the swimmer. Therefore, the supervising individual is advised that user 124 may be in distress and potentially drowning such that the appropriate rescue efforts may be immediately commenced, if necessary.

If user 124 should happen to resurface after alarm 68 has been activated by microcontroller 64, microcontroller 64 may be programmed to automatically deactivate the alarm 68. In the alternative, microcontroller 64 may instead require alarm 68 to keep issuing the warning until manually deactivated by the supervising individual via base station 14.

From the foregoing, those skilled in the art will recognize that drowning alert system 10 provides an initial warning when, for example, a person has gone underwater and a subsequent warning when the person has been underwater for a potentially dangerous length of time.

What is claimed is:

1. A drowning alert system comprising;
a base station configured to receive a radio frequency signal from a transmission device supported by a user and suitable for use within water, the base station configured to activate an indicator in response to a lack of receipt of the radio frequency signal.

2. The system of claim 1, wherein the base station is configured to activate an alarm in response the lack of receipt of the radio frequency signal for a predetermined amount of time.

3. The system of claim 2, wherein the indicator is a visual indicator and the alarm is an audible alarm.

4. The system of claim 2, wherein the base station includes a selector switch employed to select the predetermined amount of time.

5. The system of claim 4, wherein the selector switch includes a plurality of settings based upon a swimming skill level of the user.

6. The system of claim 2, wherein the predetermined amount of time is based upon a swimming skill level of the user.

7. The system of claim 1, wherein the base station is configured to activate an audible alarm following activation of the indicator.

8. A drowning alert system comprising:
a transmission device supported by a user and suitable for use within water, the transmission device including a radio frequency transmitter configured to broadcast a radio frequency signal; and
a base station including a radio frequency receiver configured to receive the radio frequency signal, the base station configured to activate an indicator in response to the radio frequency transmitter being submerged in the water.

9. The system of claim 8, wherein the base station is configured to activate an alarm a predetermined amount of time after the radio frequency transmitter is submerged in water.

10. The system of claim 9, wherein the indicator is a visual indicator and the alarm is an audible alarm.

11. The system of claim 9, wherein the base station includes a selector switch employed to select the predetermined amount of time.

12. The system of claim 9, wherein the predetermined amount of time is based upon a skill level of the user.

13. The system of claim 11, wherein the selector switch includes a plurality of settings based upon a swimming skill level of the user.

14. The system of claim 9, wherein the transmission device includes a liquid impervious housing protecting the radio frequency transmitter from direct contact with the water.

15. The system of claim 9, wherein the transmission device includes a reed switch operable to transition the transmission device between an operating state and a non-operating state upon application of a magnetic field.

16. The system of claim 9, wherein the transmission device includes a rechargeable battery.

17. The system of claim 9, wherein the transmission device includes a wireless charging module configured to recharge a battery using received radio frequency signals.

18. The system of claim 9, wherein the transmission device is supported by a head of the user.

19. A drowning alert system comprising:
a transmission device supported by a user and suitable for use within water, the transmission device including a radio frequency transmitter configured to broadcast a radio frequency signal; and
a base station including a radio frequency receiver configured to receive the radio frequency signal, the base station configured to illuminate a visual indicator in response to lack of a radio frequency signal and to emit an audible alarm in response to lack of the radio frequency signal for a predetermined amount of time.

20. The drowning alert system of claim 19, wherein the base station includes a selector switch employed to manipulate the predetermined amount of time based upon a swimming skill level of the user.
